(19) United States
(12) Patent Application Publication
(10) Pub. No.: US 2025/0291206 A1
(43) Pub. Date: Sep. 18, 2025

(54) DIMMABLE EYEGLASSES

(71) Applicant: Wicue USA INC., Santa Clara, CA (US)

(72) Inventors: Fenghua LI, Santa Clara, CA (US); Kangsheng XIE, Santa Clara, CA (US); Jian QIU, Santa Clara, CA (US); Jianshun LUO, Santa Clara, CA (US); Yanbin LI, Santa Clara, CA (US)

(73) Assignee: Wicue USA INC., Santa Clara, CA (US)

(21) Appl. No.: 18/602,965

(22) Filed: Mar. 12, 2024

(51) Int. Cl. G02C 7/10; G02F 1/133; G02F 1/1333; G02F 1/1343

(52) U.S. Cl. CPC G02C 7/101; G02F 1/13306; G02F 1/133305; G02F 1/133308; G02F 1/134309

(57) ABSTRACT

This application discloses a type of dimmable eyeglasses, which include a frame, dimmable lenses, a first temple, a second temple, a circuit board, a battery, and conductive connectors. The dimmable lenses are disposed in the frame, with the first temple hinged on a side of the frame, and the second temple hinged on the other side. The circuit board is located in the first temple, and the battery is placed in the second temple. An electrical connection component is installed in the frame, with parts extending into both the first and second temples. The dimmable lenses and the battery are electrically connected to the circuit board through the electrical connection component.

### TECHNICAL FIELD

This application relates to a field of eyeglass technology, and in particular, to a type of dimmable eyeglasses.

### BACKGROUND

In daily life, especially in summer when the sunlight is strong, there is often discomfort from the glare of the sun. Since human vision primarily relies on the eyes, it can be hazardous when the eyes are unable to open properly due to bright sunlight. To avoid this, people wear sunglasses to shield against the glaring sun, allowing for normal vision. However, standard sunglasses are not suitable for people with myopia, and their light transmittance is fixed and unchangeable. Since the intensity of sunlight varies throughout the day, sunglasses with a constant transmittance cannot provide the most comfortable state for the eyes under varying light conditions, nor can they offer the best vision when worn. To solve these problems, dimmable glasses were developed, which can adjust the transmittance of the lenses according to different intensities of ambient light.

However, in existing, dimmable glasses, electronic components are usually placed in only one temple, resulting in uneven pressure on the ears when worn, which diminishes the user's wearing experience. Therefore, there is an urgent need for a technical solution that addresses this issue.

### SUMMARY

An objective of this application is to provide a type of dimmable eyeglasses aimed at improving the technical issue of uneven force on the left and right sides experienced by users while wearing existing dimmable eyeglasses.

To achieve the above objective, this application provides a type of dimmable eyeglasses, including:
a frame;
a dimmable lens disposed within the frame;
a first temple, hinged to one side of the frame;
a second temple, hinged to the other side of the frame;
a circuit board, located within the first temple;
a battery, located within the second temple; and
an electrical connection component, disposed within the frame, part of which extends into the first temple and the second temple, wherein the dimmable lens, the circuit board, and the battery are electrically connected to the circuit board through the electrical connection component.

Alternatively, in some embodiments of this application, the eyeglasses include two of the dimmable lenses, spaced within the frame;

the electrical connection component includes a first conductive part, a first connecting part, a second conductive part, a second connecting part, and a third conductive part, the first conductive part extends into the first temple and is electrically connected to the circuit board, the first connecting part, the second conductive part, and the second connecting part are disposed within the frame, both of the dimmable lenses are bound to the second conductive part, the third conductive part extends into the second temple and is electrically connected to the battery.

Alternatively, in some embodiments of this application, the electrical connection component is equipped with a first wire and a second wire;
the first wire extends from the first conductive part through the first connecting part to the second conductive part, with the first end of the first wire electrically connected to the circuit board and the second end electrically connected to the dimmable lens;
the second wire extends from the first conductive part through the first connecting part, the second conductive part, and the second connecting part to the third conductive part, with the first end of the second wire electrically connected to the circuit board and the second end electrically connected to the battery.

Alternatively, in some embodiments of this application, the electrical connection component includes four of the first wires and two of the second wires;
each of the dimmable lenses corresponds to two of the first wires, with the positive and negative electrodes of the dimmable lenses respectively electrically connected to the circuit board through their corresponding first wires;
the positive electrode of the battery is electrically connected to the circuit board through one of the second wires, and the negative electrode of the battery is electrically connected to the circuit board through another of the second wires.

Alternatively, in some embodiments of this application, the dimmable lens includes a lens and a liquid crystal film, the liquid crystal film is adhered to one side of the lens, the liquid crystal film includes, in sequence, a first flexible substrate, a first conductive layer, a liquid crystal layer, a second conductive layer, and a second flexible substrate, with the positive electrode of the dimmable lens disposed at the first conductive layer and the negative electrode disposed at the second conductive layer.

Alternatively, in some embodiments of this application, the frame includes a front frame and a rear frame, the rear frame is assembled to the front frame, the edges of the dimmable lenses are clamped between the front frame and the rear frame, and a part of the electrical connection component is disposed between the dimmable lens and the front frame.

Alternatively, in some embodiments of this application, the front frame and the rear frame are snap-fitted and connected.

Alternatively, in some embodiments of this application, each end of the front frame is provided with a first fixing part, and each end of the rear frame is provided with a second fixing part, the first fixing part and the second fixing part correspond one-to-one, and the second fixing part is located on one side of the corresponding said first fixing part;
the frame further includes two pile heads and at least two fasteners, the two said pile heads are respectively disposed at the ends of the front frame, the pile heads are disposed on the side of the corresponding said first fixing part away from the second fixing part; the fasteners secure the corresponding said second fixing part, the first fixing part, and the pile head together.

Alternatively, in some embodiments of this application, the first temple includes a first main body and a first cover, the first cover is assembled to the first main body, the first main body and the first cover together enclose a first housing cavity, the circuit board is located within the first housing cavity; the first main body is hinged to one of the pile heads through a first hinge.

Alternatively, in some embodiments of this application, the second temple includes a second main body and a second cover, the second cover is assembled to the second main body, the second main body and the second cover together enclose a second housing cavity, the battery is located within the second housing cavity; the second main body is hinged to the other of the pile heads through a second hinge.

Compared to existing technologies, the beneficial effects of the technical solution in this application are as follows:

Compared to the scheme of setting the circuit board and battery in the same temple of the glasses, this application arranges the circuit board in the first temple and the battery in the second temple. This makes the pressure on the left and right ears more balanced when the user wears dimmable glasses, which is conducive to improving the user's wearing experience.

### BRIEF DESCRIPTION OF THE DRAWINGS

FIG. 1 is a schematic diagram of the three-dimensional structure of the dimmable glasses in the embodiment of this application;

FIG. 2 is an exploded schematic diagram of the dimmable glasses in the embodiment of this application;

FIG. 3 is a schematic diagram of the three-dimensional structure of the conductive connector in the embodiment of this application;

FIG. 4 is a planar schematic diagram of the conductive connector in the embodiment of this application;

FIG. 5 is an enlarged schematic diagram of area A in FIG. 4;

FIG. 6 is an exploded structural schematic diagram of the dimmable lens in the embodiment of this application;

FIG. 7 is a schematic diagram of the cross-sectional structure of the dimmable glasses in the embodiment of this application.

### LIST OF REFERENCE SIGNS

| Reference | |
|---|---|
| Number | Component Name |
| 100 | Frame |
| 110 | Front Frame |
| 111 | First Fixing Part |
| 120 | Rear Frame |
| 121 | Second Fixing Part |
| 130 | Pile Head |
| 140 | Fastener |
| 200 | Dimmable Lens |
| 210 | Lens |
| 220 | Liquid Crystal Film |
| 221 | First Flexible Substrate |
| 222 | First Conductive Layer |
| 223 | Liquid Crystal Layer |
| 224 | Second Conductive Layer |
| 225 | Second Flexible Substrate |
| 300 | First Temple |
| 310 | First Body |
| 320 | First Cover |
| 330 | First Housing Cavity |
| 340 | First Hinge |
| 400 | Second Temple |
| 410 | Second Body |
| 420 | Second Cover |
| 430 | Second Housing Cavity |
| 440 | Second Hinge |
| 500 | Circuit Board |
| 600 | Battery |
| 700 | Conductive Connector |
| 710 | First Conductive Part |
| 720 | First Connection Part |
| 730 | Second Conductive Part |
| 740 | Second Connection Part |
| 750 | Third Conductive Part |
| 760 | First Wire |
| 770 | Second Wire |

### DETAILED DESCRIPTION

Hereinafter, with reference to the drawings in the embodiments of the present disclosure, a clear and complete description of the schemes in the embodiments of the present disclosure will be provided. It should be apparent that the described embodiments are only a portion of the embodiments of the present disclosure, not all of them. Based on the embodiments of the present disclosure, all other embodiments that those skilled in the art obtain without making inventive contributions fall within the scope of protection of the present disclosure.

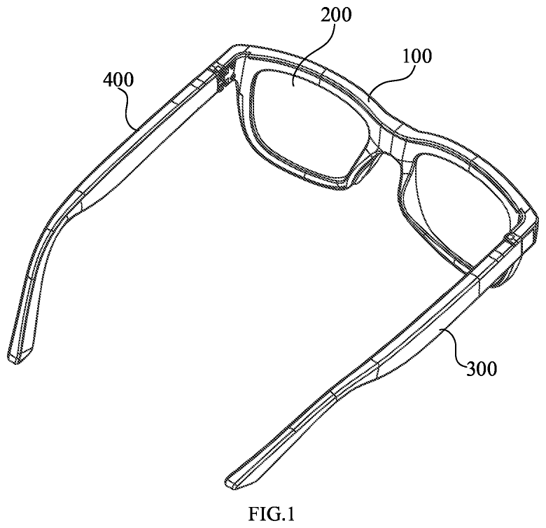

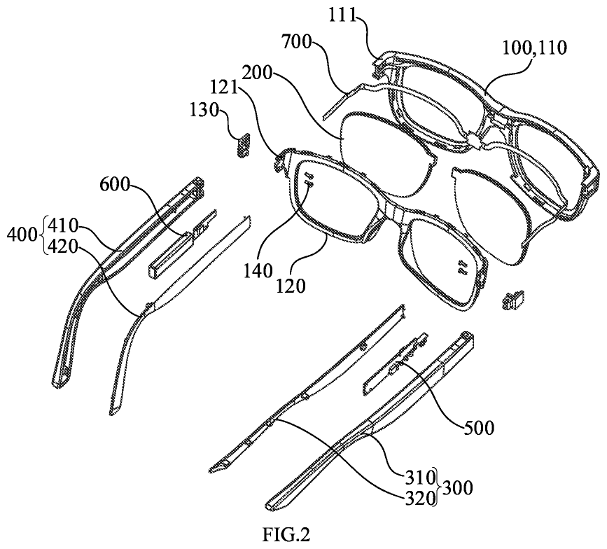

Please refer to FIG. 1 and FIG. 2. The embodiment of this application provides a pair of dimmable glasses, including a frame 100, dimmable lenses 200, a first temple 300, a second temple 400, a circuit board 500, a battery 600, and conductive connectors 700. The dimmable lenses 200 are situated in the frame 100. The first temple 300 is hinged to one side of the frame 100, and the second temple 400 is hinged to the other side. The circuit board 500 is located in the first temple 300, and the battery 600 is placed in the second temple 400. The conductive connectors 700 are situated in the frame 100, partially extending into the first temple 300 and the second temple 400. The dimmable lenses 200, circuit board 500, and battery 600 are electrically connected to the circuit board 500 through the conductive connectors 700, meaning the dimmable lenses 200 are electrically connected to the circuit board 500 via corresponding conductive paths on the conductive connectors 700. Similarly, the battery 600 is electrically connected to the circuit board 500 through its respective conductive paths on the conductive connectors 700.

Compared to configurations where the circuit board and battery are placed in the same temple, this application, by setting the circuit board 500 in the first temple 300 and the battery 600 in the second temple 400, ensures more even distribution of pressure on the wearer's ears, thus improving the user's wearing experience.

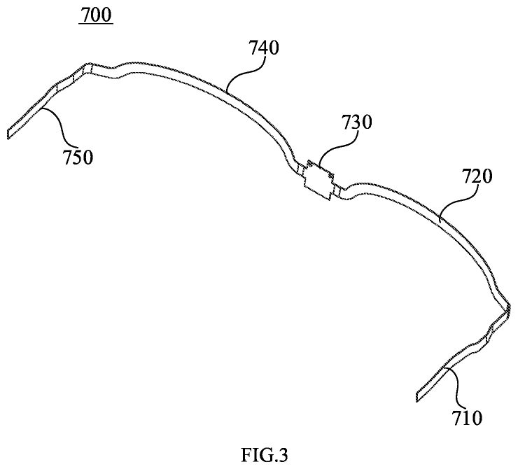

Specifically, as shown in FIG. 1 and FIG. 2, the dimmable glasses include two dimmable lenses 200, spaced apart in the frame 100. As combined in FIG. 2 and FIG. 3, the conductive connectors 700 include sequentially connected first conductive part 710, first connection part 720, second conductive part 730, second connection part 740, and third conductive part 750. The first conductive part 710 extends into the first temple 300 and is electrically connected to the circuit board 500. The first connection part 720, second conductive part 730, and second connection part 740 are situated in the frame 100, with the two dimmable lenses 200 bound to the second conductive part 730. The third conductive part 750 extends into the second temple 400 and is electrically connected to the battery 600. This configuration allows for easier binding or soldering operations, ensuring adequate space for the connection of the circuit board 500, dimmable lenses 200, and battery 600.

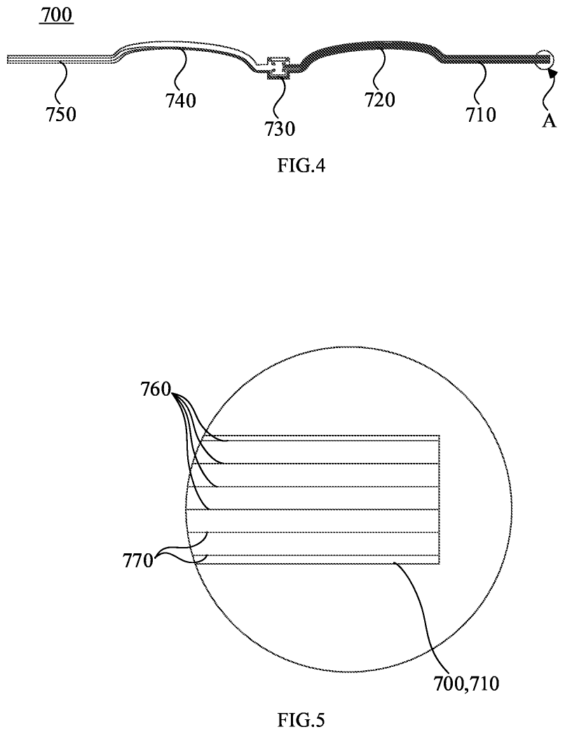

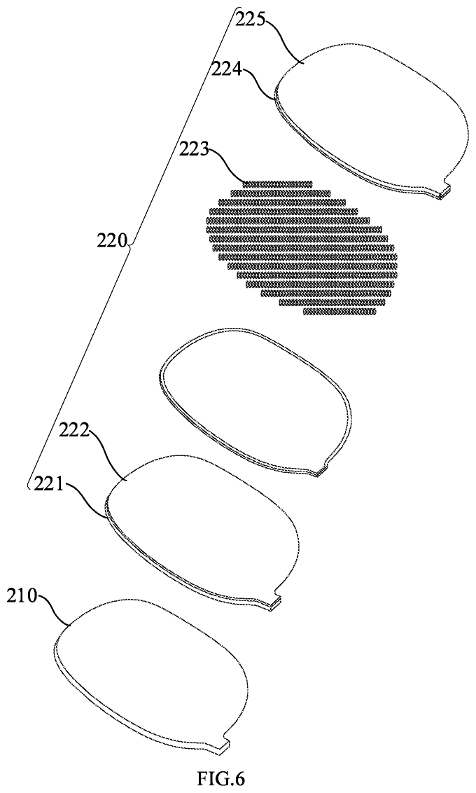

More specifically, as combined in FIG. 2, FIG. 4, and FIG. 5, the conductive connectors 700 are equipped with first wire 760 and second wire 770. The first wire 760 extends from the first conductive part 710 through the first connection part 720 to the second conductive part 730, with its first end electrically connected to the circuit board 500 and its second end electrically connected to the dimmable lens 200. The second wire 770 extends from the first conductive part 710 through the first connection part 720, the second conductive part 730, and the second connection part 740 to the third conductive part 750, with its first end electrically connected to the circuit board 500 and its second end electrically connected to the battery 600. This arrangement ensures that the dimmable lens 200 is electrically connected to the circuit board 500 via the first wire 760, and the battery 600 is electrically connected to the circuit board 500 via the second wire 770.

In further detail, as combined in FIG. 2, FIG. 4, and FIG. 5, the conductive connectors 700 include four first wires 760 and two second wires 770. Each dimmable lens 200 corresponds to two first wires 760, with the positive and negative electrodes of the dimmable lens 200 electrically connected to the circuit board 500 through their respective first wires 760. The positive electrode of the battery 600 is electrically connected to the circuit board 500 through one of the second wires 770, and the negative electrode is connected through the other second wire 770.

In the embodiment of this application, the conductive connectors 700 can be flexible printed circuits (FPC).

Specifically, as shown in FIG. 6, the dimmable lens 200 includes a lens 210 and a liquid crystal film 220. The liquid crystal film 220 is affixed to one side of the lens 210 and includes sequentially stacked first flexible substrate 221, first conductive layer 222, liquid crystal layer 223, second conductive layer 224, and second flexible substrate 225. The positive electrode of the dimmable lens 200 is located at the first conductive layer 222, and the negative electrode is at the second conductive layer 224.

Specifically, as shown in FIG. 2, the frame 100 includes a front frame 110 and a rear frame 120. The rear frame 120 is assembled to the front frame 110, with the edges of the dimmable lens 200 clamped between the front frame 110 and the rear frame 120, and part of the conductive connector 700 is situated between the dimmable lens 200 and the front frame 110. This structure, by designing the frame 100 as a split type, facilitates the assembly of the dimmable lens 200 and the conductive connector 700. In this embodiment, the front frame 110 and the rear frame 120 can be fixed together through a snap and connect mechanism.

Specifically, as shown in FIG. 2, the front frame 110 has first fixing parts 111 at both ends, and the rear frame 120 has second fixing parts 121 at both ends, corresponding to the first fixing parts 111. The second fixing parts 121 are located on the side of the corresponding first fixing parts 111. The frame 100 also includes two pile heads 130 and at least two fasteners 140. The two pile heads 130 are located at the ends of the front frame 110, on the side of the corresponding first fixing parts 111 that is away from the second fixing parts 121. The fasteners 140 secure the corresponding second fixing parts 121, first fixing parts 111, and pile heads 130 together. In this embodiment, the fasteners 140 can be screws, which after passing through the second fixing parts 121 and the first fixing parts 111, are threadedly connected to the pile heads 130, thereby further securing the front frame 110 and the rear frame 120 together.

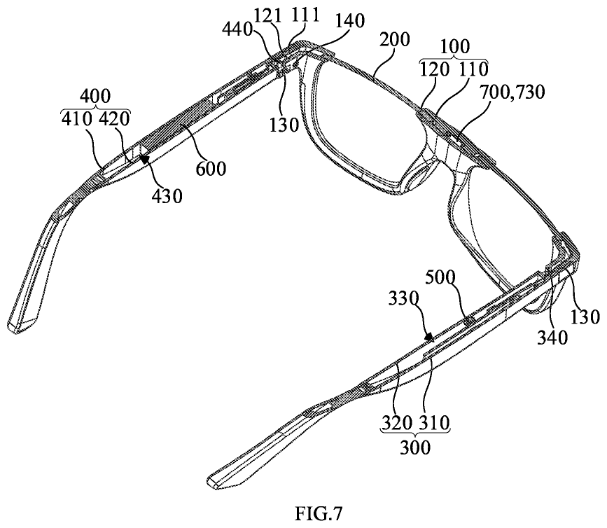

Specifically, as shown in FIG. 2 and FIG. 7, the first temple 300 includes a first body 310 and a first cover 320. The first cover 320 is assembled to the first body 310, and together they enclose a first housing cavity 330. The circuit board 500 is located within the first housing cavity 330. The first body 310 is hinged to one of the pile heads 130 through a first hinge 340.

Specifically, as shown in FIG. 2 and FIG. 7, the second temple 400 includes a second body 410 and a second cover 420. The second cover 420 is assembled to the second body 410, and together they enclose a second housing cavity 430. The battery 600 is located within the second housing cavity 430. The second body 410 is hinged to the other pile head 130 through a second hinge 440.

It should be noted that the technical solutions of the various embodiments of this application can be combined with each other. However, such combinations must be based on what can be implemented by those skilled in the art. When the combination of technical solutions results in contradictions or impracticalities, such combinations should be considered non-existent and are not within the scope of protection sought by this application.

The above descriptions are only some or preferred embodiments of this application. The scope of protection of this application should not be limited to the text or the drawings. Any equivalent structural modifications made under the overall concept of this application, utilizing the content of the specification and the drawings, or directly/indirectly applied in other related technical fields, are included within the scope of protection of this application.

What is claimed is:

1. A dimmable eyeglasses comprising:
a frame;
a dimmable lens disposed within the frame;
a first temple, hinged to a side of the frame;
a second temple, hinged to an opposite side of the frame;
a circuit board, located within the first temple;
a battery, located within the second temple; and
an electrical connection component, disposed within the frame, part of which extends into the first temple and the second temple, wherein the dimmable lens and the battery are electrically connected to the circuit board through the electrical connection component.

2. The dimmable eyeglasses of claim 1, wherein the dimmable lens include two dimmable lens spaced apart from each other within the frame;
the electrical connection component comprises a first conductive part, a first connecting part, a second conductive part, a second connecting part, and a third conductive part, the first conductive part extends into the first temple and is electrically connected to the circuit board, the first connecting part, the second conductive part, and the second connecting part are disposed within the frame, the two dimmable lens are bound to the second conductive part, and the third conductive part extends into the second temple and is electrically connected to the battery.

3. The dimmable eyeglasses of claim 2, wherein the electrical connection component further comprises one or more first wires and one or more second wires;
each of the one or more first wires extends from the first conductive part through the first connecting part to the second conductive part, with a first end of the first wire electrically connected to the circuit board and a second end of the first wire electrically connected to the two dimmable lens; and
each of the one or more second wires extends from the first conductive part through the first connecting part, the second conductive part, and the second connecting part to the third conductive part, with a first end of the second wire electrically connected to the circuit board and a second end of the second wire electrically connected to the battery.

4. The dimmable eyeglasses of claim 3, wherein the one or more first wires include four first wires and the one or more second wires include two second wires;
each of the dimmable lenses corresponds to two corresponding ones of the four first wires, with a positive electrode and a negative electrode of the dimmable lens respectively electrically connected to the circuit board through the two corresponding ones of the four first wires;
a positive electrode of the battery is electrically connected to the circuit board through one of the two second wires, and a negative electrode of the battery is electrically connected to the circuit board through another one of the two second wires.

5. The dimmable eyeglasses of claim 4, wherein the dimmable lens comprises a lens and a liquid crystal film, the liquid crystal film is adhered to a side of the lens, the liquid crystal film comprises, in sequence, a first flexible substrate, a first conductive layer, a liquid crystal layer, a second conductive layer, and a second flexible substrate, with the positive electrode of the dimmable lens disposed at the first conductive layer and the negative electrode of the dimmable lens disposed at the second conductive layer.

6. The dimmable eyeglasses of claim 1, wherein the frame comprises a front frame and a rear frame, the rear frame is assembled to the front frame, edges of the dimmable lenses are held between the front frame and the rear frame, and a part of the electrical connection component is disposed between the dimmable lens and the front frame.

7. The dimmable eyeglasses of claim 2, wherein the frame comprises a front frame and a rear frame, the rear frame is assembled to the front frame, edges of the dimmable lenses are held between the front frame and the rear frame, and a part of the electrical connection component is disposed between the dimmable lens and the front frame.

8. The dimmable eyeglasses of claim 3, wherein the frame comprises a front frame and a rear frame, the rear frame is assembled to the front frame, edges of the dimmable lenses are held between the front frame and the rear frame, and a part of the electrical connection component is disposed between the dimmable lens and the front frame.

9. The dimmable eyeglasses of claim 4, wherein the frame comprises a front frame and a rear frame, the rear frame is assembled to the front frame, edges of the dimmable lenses are held between the front frame and the rear frame, and a part of the electrical connection component is disposed between the dimmable lens and the front frame.

10. The dimmable eyeglasses of claim 5, wherein the frame comprises a front frame and a rear frame, the rear frame is assembled to the front frame, edges of the dimmable lenses are held between the front frame and the rear frame, and a part of the electrical connection component is disposed between the dimmable lens and the front frame.

11. The dimmable eyeglasses of claim 6, wherein the front frame and the rear frame are snap-fitted and connected.

12. The dimmable eyeglasses of claim 6, wherein each of both ends of the front frame is provided with a first fixing part, and each of both ends of the rear frame is provided with a second fixing part, the first fixing part and the second fixing part correspond one-to-one, and the second fixing part is located on a side of the first fixing part;
the frame further comprises two pile heads and at least two fasteners, the two pile heads are respectively disposed at the ends of the front frame, the pile head are disposed on a side of the first fixing part away from the second fixing part; and the fastener secures the second fixing part, the first fixing part, and the pile head together.

13. The dimmable eyeglasses of claim 12, wherein the first temple comprises a first main body and a first cover, the first cover is assembled to the first main body, the first main body and the first cover together enclose a first housing cavity, the circuit board is located within the first housing cavity; and the first main body is hinged to one of the pile heads through a first hinge.

14. The dimmable eyeglasses of claim 12, wherein the second temple comprises a second main body and a second cover, the second cover is assembled to the second main body, the second main body and the second cover together enclose a second housing cavity, the battery is located within the second housing cavity; and the second main body is hinged to another one of the pile heads through a second hinge.
